(19) United States
(12) Patent Application Publication
(10) Pub. No.: US 2017/0140342 A1
(43) Pub. Date: May 18, 2017

(54) VALUE-BASED ORGANIZATION

(71) Applicant: Mycore, LLC, Salt Lake City, UT (US)

(72) Inventors: Christopher Michael Jones, Salt Lake City, UT (US); Corey Lynn Wride, Salt Lake City, UT (US); Corey Kent Berg, Salt Lake City, UT (US)

(73) Assignee: Mycore, LLC, Salt Lake City, UT (US)

(21) Appl. No.: 15/320,011

(22) PCT Filed: Jun. 19, 2014
(86) PCT No.: PCT/US2014/043176

§ 371 Date: Dec. 19, 2016

(51) Int. Cl. G06Q 10/10

(52) U.S. Cl. CPC G06Q 10/1097

(57) ABSTRACT

A method of value-based organization comprises, with a processor, receiving an input value, receiving a selection of a goal, in which the goal is associated with the input value, receiving a number of steps based on the value, the goal, or combinations thereof, populating a choice list with a portion of the number of steps, the portion populated being a number of tasks in the choice list, and populating a task list with a selected number of tasks from the choice list by assigning a temporal value to the selected number of tasks.

### BACKGROUND

Electronic devices have become increasingly valuable in an individual's day-to-day operations. This is evidenced by the development of increased electronic device functionality to meet consumer demand. The value of electronic devices is compounded by today's fast-paced lifestyle where individuals juggle multiple roles and schedules. Electronic devices may be used to help an individual keep up with such a fast-paced, multi-faceted lifestyle.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a data processing system for implementing value-based organization, according to one example of the principles described herein.

FIG. 2 is a flowchart showing a method for implementing value-based organization, according to one example of the principles described herein.

FIG. 3 is a flowchart showing a method for implementing value-based organization, according to another example of the principles described herein.

FIG. 4 is a flowchart showing a method for providing value-based organization, according to one example of the principles described herein.

FIG. 5 is a flowchart showing a method for providing value-based organization, according to another example of the principles described herein.

FIG. 6 is a block diagram of a value interface, according to one example of the principles described herein.

FIG. 7 is a block diagram of a value detail interface, according to one example of the principles described herein.

FIG. 8 is a block diagram of a goal detail interface, according to one example of the principles described herein.

FIG. 9 is a block diagram of a planning interface according to one example of the principles described herein.

FIG. 10 is a block diagram of an event view of a mobile device application for value-based organization, according to one example of the principles described herein.

FIG. 11 is a block diagram of a task view of a mobile device application for value-based organization, according to one example of the principles described herein.

FIG. 12 is a block diagram of a choice list interface, according to one example of the principles described herein.

Throughout the drawings, identical reference numbers designate similar, but not necessarily identical, elements.

### DETAILED DESCRIPTION

In today's world, individuals are leading increasingly busy and multi-faceted lifestyles. For example, it is not uncommon for an individual to juggle a family, a profession, community service, local government activity, religious participation, and exercise activities, among other social, personal and professional activities. These numerous activities include the completion of tasks, performance of assignments, and attendance at various types of meetings or events. The satisfactory involvement in these multiple spheres may lead to a feeling of self-fulfillment and personal satisfaction. By comparison, a less than satisfactory involvement in any number of these spheres may lead to stress, unhappiness, and other troubling emotions. For example, focusing a significant amount of time on professional development, at the expense of familial relationship with, for example, a spouse or children, may induce negative emotions in the individual, and the individual's family. Further, the negative emotions may be reflected in other aspects of the individual's life.

Accordingly, many publications have been published to assist in the satisfactory participation in these spheres. For example, health programs are designed to encourage a satisfactory exercise regime. As another example, family science programs have been developed to encourage stable family relationships. Moreover, tools have been designed to manage the different facets of an individual's life.

However, current methods for organizing events and activities in an individual's life may be ineffective. For example, many of the current methods and tools may lack a practical implementation. More specifically, current tools may offer a goal selection tool yet lack a series of practical intermediate steps to assist an individual in achieving that goal. Current methods and systems may also not provide adequate integration into an individual's day-to-day schedule. For example, many health programs are available as published books, which may not be on hand throughout the day, and therefore may be less effective. Additionally, electronic organization tools may not allow an individual to correlate daily tasks with values the individual is working to develop, or that the individual deems as valuable. Moreover, current programs may not facilitate an easy customization of program steps based on an individual's schedule or availability.

Accordingly, the present disclosure describes a method and system for value-based organization. The method may include receiving an input value and a selection of a goal. The method may further include receiving a number of steps based on the value, the goal, or combinations thereof. The method may also include populating a choice list with a portion of the number of steps, the portion populated being a number of tasks in the choice list. The method also includes populating a task list with a selected number of tasks from the choice list by assigning a temporal value to the selected number of tasks.

The present disclosure also describes a method of providing value-based organization. The method may include obtaining a program. As described above, the program may include a number of program steps. The method also may include uploading the program to a program database, and displaying a list of a number of programs.

The present disclosure also describes a system for value-based organization. The system may include a program database for storing a number of programs. The number of programs may include a number of program steps. The system also may include a display device to display the number of programs, a choice list, a task list, or combinations thereof. The system may also include a value generation engine to allow generation of a value. The system may include a goal generation engine to allow generation of a goal based on the value. The system may also include a program generation engine to allow generation of a program based on the value, goal, or combinations thereof. The system may further include a choice list generation engine to allow generation of a number of program steps from the choice list.

The systems and methods described herein may be beneficial by facilitating value-based habit formation and organization. In other words, the systems and methods described herein may provide a tool to manage different activities of an individual's life, while monitoring the participation in facets of an individual's life that the individual has deemed valuable. Moreover, the systems and methods described herein allow for the customization of programs based on the individual's particular life circumstances.

Additionally, as described above, numerous publications have been generated to facilitate the achievement of a particular goal. The systems and methods described herein centralize a number of these programs, and publishes the programs in a practical form that may be implemented on an electronic device at any moment. In summary, the systems and methods described herein provide knowledge for the satisfactory participation in the many aspects of an individual's life in a simple interface, and also provides tools for successfully accomplishing tasks relating to those aspects by bringing together program authors and individuals wanting to implement those programs.

As used in the present specification and in the appended claims, the term “value” is meant to be understood broadly as any facet of an individual's life or an organization's operation deemed valuable, or that an individual or organization intends to develop. For example, a value may include familial stability, financial independence, organizational integrity, and spirituality, among other social, personal, and professional values.

Further, as used in the present specification and in the appended claims, the term “program” is meant to be understood broadly as a number of program steps whose performance is meant to achieve a particular end. In some examples the steps of a program may be intended to be carried out sequentially. In other examples, the steps may be intended to be performed in any order. A financial independence program may include a number of program steps whose performance is meant to lift an individual out of debt. In another example, a health program may include a number of program steps whose performance is meant to allow an individual to reduce their weight. Programs may be expert programs, i.e., programs created by a third-party expert relative to the program. Programs may also be created by a user. For example, a user may generate a specific goal and may generate a number of steps to achieve the goal. The generated number of steps may be defined as a program.

Still further, as used in the present specification and in the appended claims, the term “task” is meant to be understood broadly as a program step, or a non-program step, that has been selected by a user. In other words, a task is a program step or a non-program step that a user has selected to perform. A task in a choice list may not have a temporal commitment for performance. When populated to a task list, a task may be assigned a temporal commitment for performance. For example, a step to “cancel credit card” may become a task when populated to the choice list and may be moved to a task list and assigned to be completed on a particular date, or by a particular date.

Lastly, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

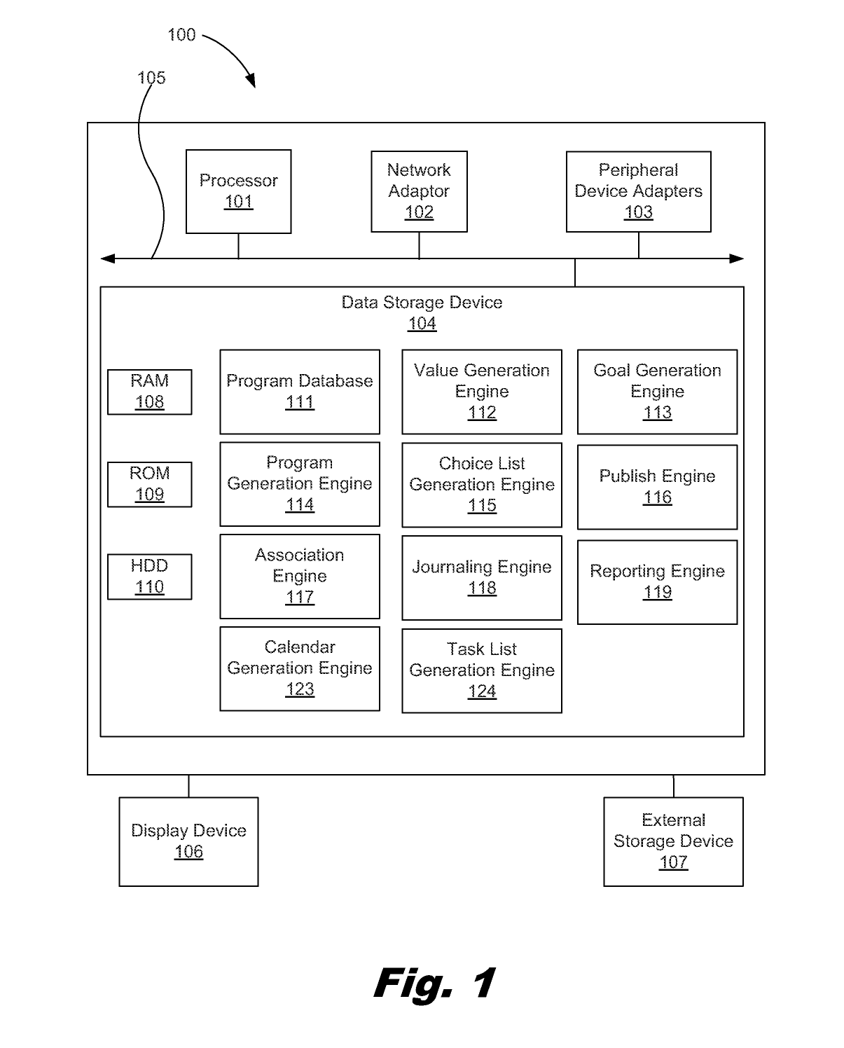

Turning now to the figures, FIG. 1 is a diagram of a data processing system (100) for implementing value-based organization, according to one example of the principles described herein. The data processing system (100) may be implemented in an electronic device. Examples of electronic devices include desktop computers, laptop computers, personal digital assistants (PDAs), mobile devices, smartphones, gaming systems, and tablets, among other electronic devices.

The data processing system (100) may be utilized in any data processing scenario including, hardware, mobile application, a network, or combinations thereof. Further, the data processing system (100) may be used in a computing network, a public cloud network, a private cloud network, a hybrid cloud network, other forms of networks, or combinations thereof. In one example, the methods provided by the data processing system (100) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the data processing system (100) are executed by a local administrator.

To achieve its desired functionality, the data processing system (100) comprises various hardware components. Among these hardware components may be a number of processors (101), a number of data storage devices (104), a number of peripheral device adapters (103), and a number of network adapters (102). These hardware components may be interconnected through the use of a number of busses and/or network connections. In one example, the processor (102), data storage device (104), peripheral device adapters (103), and a network adapter (102) may be communicatively coupled via a bus (105).

The processor (101) may include the hardware architecture to retrieve executable code from the data storage device (104) and execute the executable code. The executable code may, when executed by the processor (101), cause the processor (101) to implement at least the functionality of value-based organization, according to the methods of the present specification described herein. In the course of executing code, the processor (101) may receive input from and provide output to a number of the remaining hardware units.

The data storage device (104) may store data such as executable program code that is executed by the processor (101) or other processing device. As will be discussed, the data storage device (104) may specifically store a number of applications that the processor (101) executes to implement at least the functionality described herein.

The data storage device (104) may include various types of memory modules, including volatile and nonvolatile memory. For example, the data storage device (104) of the present example includes Random Access Memory (RAM) (108), Read Only Memory (ROM) (109), and Hard Disk Drive (HDD) memory (110). Many other types of memory may also be utilized, and the present specification contemplates the use of many varying type(s) of memory in the data storage device (104) as may suit a particular application of the principles described herein. In certain examples, different types of memory in the data storage device (104) may be used for different data storage needs. For example, in certain examples the processor (101) may boot from Read Only Memory (ROM) (109), maintain nonvolatile storage in the Hard Disk Drive (HDD) memory (110), and execute program code stored in Random Access Memory (RAM) (108).

Generally, the data storage device (104) may comprise a computer readable medium, a computer readable storage medium, or a non-transitory computer readable medium, among others. For example, the data storage device (104) may be, but is not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103) in the data processing system (100) enable the processor (101) to interface with various other hardware elements, external and internal to the data processing system (100). For example, peripheral device adapters (103) may provide an interface to input/output devices, such as, for example, display device (106), a mouse, or a keyboard. The peripheral device adapters (103) may also provide access to other external devices such as an external storage device (107). The display device (106) may be provided to allow an individual to interact with and implement the functionality of the data processing system (100). The peripheral device adapters (103) may also create an interface between the processor (101) and a printer, the display device (106), or other media output device. The network adapter (102) may provide an interface to other computing devices within, for example, a network, thereby enabling the transmission of data between the data processing system (100) and other devices located within the network.

The data processing system (100) further comprises a number of modules used in the implementation of value-based organization. The various modules within the data processing system (100) may be executed separately. In this example, the various modules may be stored as separate computer program products. In another example, the various modules within the data processing system (100) may be combined within a number of computer program products; each computer program product comprising a number of the modules.

The data processing system (100) may include a program database (111) to store a number of programs. The processor (101) may when executed, store the programs and access such programs in accordance with the methods described herein. As described above, a program may include a number of program steps. For example, a familial stability program may include a first step to “establish a dedicated family activity hour.” The same familial stability program may include a second step to “participate in an activity the whole family enjoys.” In some examples, the program steps of a program may be designed to be performed sequentially, concurrently, or combinations thereof.

Steps may include supporting material, such as media, interactive exercises or other instructional material. For example, a step of an exercise program may include instructional videos relating to a particular exercise. Steps may also include other instructional material such as lessons that may include instructional content, exercises which may include action items, and assessments which may measure performance relative to a particular step. A number of steps within a program may be further grouped into milestones that indicate completion of a designated portion of the program.

A number of the programs may be expert programs. For example, many programs have been written and published by third parties who are experts or who have experience in a particular field. These programs may exist in the explicit form of a program, or may be embodied within another publication such as a book, an article, a technical paper, or other form of publication. For example, a financial advisor may write and publish a financial independence program.

In other examples, an author may not be an expert, but may be a lay individual who does not have professional experience in a particular field. For example, a particular individual may have developed a health program for completing a marathon. This individual, without any expertise, may publish the program, which may be included in the program database (111). In another example, the programs may be generated by the individual seeking to achieve a goal. For example, an individual may generate their own program for financial independence, which program may be included in the program database (111). The author of a program, be it an expert or a lay individual, may elect whether or not to publish a program to the program database (111). For example, a user-designed program may be used by the author, but not published to the program database (111) for use by other users. In yet another example, a program may be generated by a number of individuals, for example, via crowdsourcing.

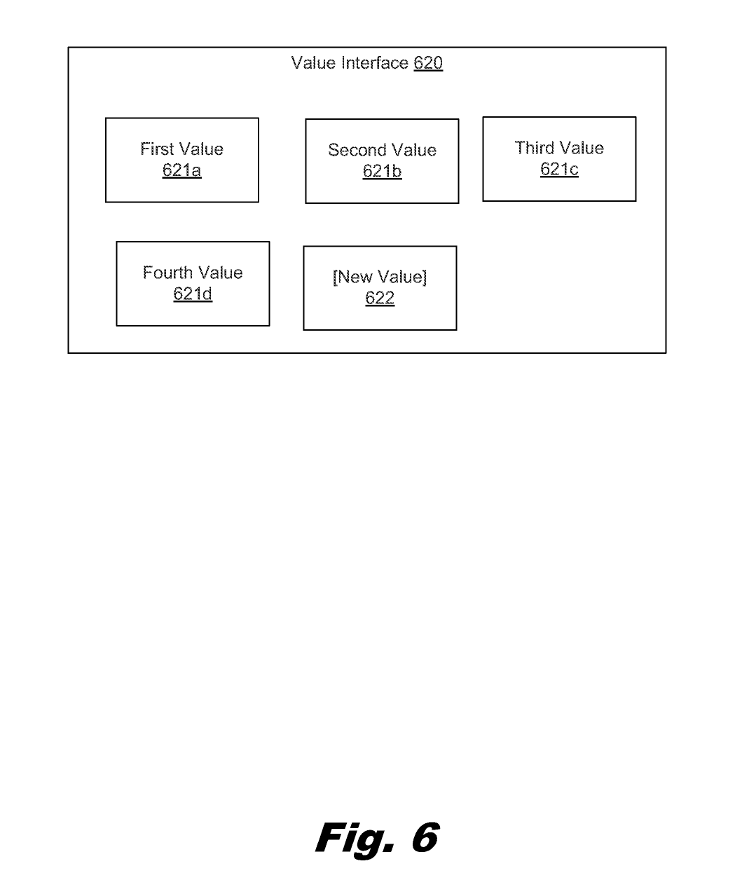

The data processing system (100) may include a display device (106) to, when executed by the processor (101), display the number of graphical user interfaces (GUIs) associated with a number of executed programs. The GUIs may include aspects of the programs including a choice list, a task list, or combinations thereof. As will be described below, steps of a program may be uploaded to a choice list as tasks. Tasks from the choice list may be selected, assigned a date, and moved to a task list. The display device (106) may display these items via a number of the GUIs. In addition to displaying various items, the GUIs of the display device (106) may allow for the selection and movement of different elements. For example, via a GUI, an individual may drag and drop a task from the choice list to a particular task list. Additionally, via gestures on a GUI of the display device (106), an individual may search for, or browse for, a number of programs associated with an input value. Examples of display devices (106) include a computer screen, a laptop screen, a mobile device screen, a personal digital assistant (PDA) screen, and a tablet screen, among other display devices (106). Examples of, and more detail describing the display device (106) and a number of GUIs, is provided in connection with FIGS. 6-12.

The data processing system (100) may include a value generation engine (112) to, when executed by the processor (101), allow generation of a value. As described above, a value may relate to a particular facet of an individual's life that the individual deems as valuable, or that the individual desires to develop. Examples of values include familial stability, health, and financial well-being, among other values. In some examples, the value generation engine (112) may allow an individual to select a value from a defined list. For example, the display device (106) may present a number of values. From these, an individual may select a particular value, or values, to develop. In another example, the value generation engine (112) may allow an individual to create a value. For example, a GUI of the display device (106) may include a field in which an individual can manually type in a particular value.

The data processing system (100) may include a goal generation engine (113) to, when executed by the processor (101), generate goals based on a value. The goals may be generated via a selection. For example, after selecting a value from a list of presented values, the goal generation engine (113) may present a number of goals related to that value. In another example, the user may create goals relating to a value presented, for example via manual entry of the goal.

The data processing system (100) may include a program generation engine (114) to, when executed by the processor (101), allow generation of a program based on the value, goal, or combinations thereof. In one example, program generation may include selection of a program from the program database (111). For example, a number of programs may exist to achieve a particular goal, or that relate to a particular value. Accordingly, the program generation engine (114) may present a number of programs from the program database (111) related to a value selected by the individual, and may allow the individual to select a particular program.

In addition, the program generation engine (114) may allow an individual to browse through, search for, or otherwise research a number of programs relating to an input value. For example, the program generation engine (114) may include a searching mechanism that allows a user to search the program database (111) to identify a particular program. The program generation engine (114) may also include a suggestion mechanism that may suggest a program to a user based on the generated values or goals. Still further, the program generation engine (114) may facilitate the purchase of a program.

The program generation engine (114) may also provide a brief description, or contextual information relating to the program to the individual. Examples of such contextual information may include authorship, a brief description of the program and a number of program entries, and statistics relating to the use, credibility, and success of the program, among other contextual information.

In another example, a user may create a program using the program generation engine (114). For example, a user may create the number of steps which may lead to the attainment of a goal.

The data processing system (100) may include a choice list generation engine (115) to, when executed by the processor (101), allow selection of a portion of the number of steps to be populated to the choice list as tasks. As will be described below, once a program is selected, a number of program steps, for example a first step, relating to the selected program is populated to a choice list. Additionally, steps not related to a program, such as, for example, those steps generated by the user or received via another input, may also be populated to the choice list.

In some examples, the data processing system (100) may include a publish engine (116) to, when executed by the processor (101), publish a program. More specifically, the publish engine (116) may publish the program in a format that can be used by the data processing system (100); a format that may be used by the program generation engine (114), the choice list generation engine (115), task list generation engine (124), or any other engine described herein. More specifically, the publish engine (116) may allow a program to be used in a user's calendar, task list or choice list as described above. The publish engine (116) may convert a text document, or a portable format document into a format that may be used by the data processing system (100). In some examples, the publish engine (116) may automatically convert a program into a format usable by the data processing system (100). In other examples, the publish engine (116) may assist an individual, by user-readable instructions for example, in publishing a program in a format that may be used by the data processing system (100). In this example, the publish engine (116) may prompt an individual to enter certain information such as a name of the program, a description, associated keywords, and a number of program steps. In some examples, the publish engine (116) may be used in conjunction with other published media. For example, an author may include a program to be used in the data processing system (100) along with a printed, or electronic, book relating to the program.

The data processing system (100) may include an association engine (117) to, when executed by the processor (101), associate a task, a program step, a non-program step, a note, an event, or combinations thereof, with a value. The association engine (117) may associate a particular task or step with an input value to monitor an individual's activity with regards to the input value. For example, the association engine (117) may indicate the association between the task “attend baseball game with son” to the value of “familial stability” by a colored icon, a text color, or a color highlight, among other indication elements.

The data processing system (100) may include a journaling engine (118) to, when executed by the processor (101) facilitate record keeping. For example, in addition to keeping track of events and activities, an individual may desire to record notes of the event or activity. Accordingly, the journaling engine (118) may present an interface in which the individual may add text, or images to a task or step. In some examples, the journaling engine (118) may integrate uploaded media to a task list. For example, the journaling engine (118) may use the time stamp of a picture to associate the picture with a task that is scheduled for that period of time.

The journaling engine (118) may also allow input of contextual information relating to the task. The contextual information may include a reminder, notes, links to other documents, a description, and tags, among other contextual information. For example, relating to a task for “cancel credit cards” in a financial independence program, an individual, via the journaling engine (118), may include a description of which credit cards are to be cancelled.

The data processing system (100) may include a reporting engine (119) to, when executed by the processor (101), generate information relative to steps, tasks, programs, goals, values, notes, or combinations thereof and to present the information to the user. For example, tasks, events, and notes that pertain to a particular value may be grouped and associated with one another and with the particular value using a colored icon, text, colored highlight, or other indication. Similarly, as will be described below, tasks, events, and notes that relate to a similar date range may be displayed and grouped as such. In another example, the reporting engine (119) may indicate how much of a user's time and resources are dedicated to particular values. For example, the reporting engine (119) may indicate that a user is spending a lot of time to the attainment of goals relating to a “work” value and is spending little time to the attainment of goals relating to a “family solidarity” value.

The data processing system (100) may include a calendar generation unit (123) to be integrated with a task list as will be described in detail below. For example, as tasks from a choice list are assigned a date and moved to a task list, the calendar generation unit (123) may generate a calendar with the events and tasks displayed along with associated values.

The data processing system (100) may include a task list generation engine (124) to generate a task list. For example, as described above, once program steps, non-program steps, or combinations thereof have been entered into a choice list as tasks, a user may assign a temporal value for the performance of a task by scheduling the task. A specific example is given as follows. In this example, a user may select a program relating to financial stability with a first step relating to cancelling credit cards. In this example, a user may schedule this step for a particular date. In some examples, the task list generation engine (124) may be implemented using a drag-and-drop type feature from a user interface.

While FIG. 1 describes the system (100) being used to attain personal goals relating to personal values, the above described system (100) may be used in an organization as well. For example, a value, goal, and program may be an organizational value, an organizational goal, and an organizational program. Similarly the tasks may be organizational tasks that are shared, delegated, or collaborated within the organization. In this example, the reporting engine (119) may report information in a hierarchical fashion. For example, within an organization, the reporting engine (119) may indicate how different hierarchical levels of the organization are complying with certain organizational values, goals, and programs.

In some examples, via the reporting engine (119), information may be sent to particular individuals. For example, a reporting message may be generated, and distributed weekly to organizational directors within an organization, stake holders, or other individuals or groups indicating which organizational units are complying with organizational values, goals, and programs. Such messages may be used in management decisions or to serve as individual and group encouragement.

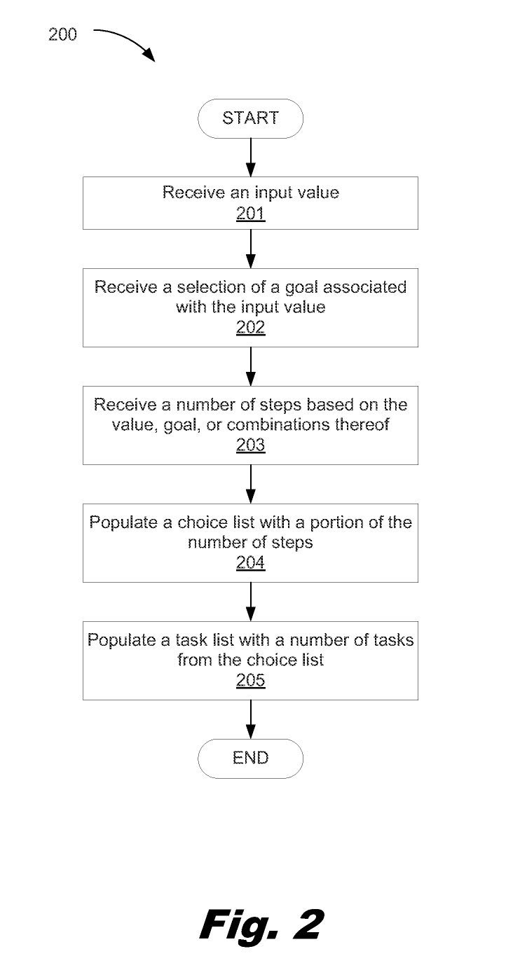

FIG. 2 is a flowchart showing a method (200) for implementing value-based organization, according to one example of the principles described herein. The method (200) may be performed by the data processing system (FIG. 1, 100). The method (200) may include receiving (block 201) an input value. As described above, a value may relate to a facet of an individual's life or an organization's operation that the individual or organization deems as valuable, or that an individual or organization desires to develop. Examples of values include familial stability, financial independence, physical well-being, professional development, and spirituality, among other values. As described above, receiving (block 201) an input value may include presenting a number of values, and receiving an indication of a selected value. For example, an individual, via a GUI on the display device (FIG. 1, 106) may select an icon relating to a particular value. In another example, receiving (block 201) an input value may include allowing creation of a value. For example, an individual, via a GUI on the display device (FIG. 1, 106), may manually enter a particular value.

The method (200) may also include receiving (block 202) a selection of a goal. For example, relating to the family stability value, a user may select a goal of spending one hour each day with a child in the user's family. In this example, the goal may be associated with the family stability value. However, in some examples, a goal may not be associated with a particular value. Receiving (block 202) selection of a goal may be via a GUI on the display device (FIG. 1, 106). In another example, receiving (block 202) a selection of a goal may include creation of a goal. For example, an individual, via a GUI on the display device (FIG. 1, 106) may manually enter a particular goal.

The method (200) may also include receiving (block 203) a number of steps based on the value, the goal, or combinations thereof. Again, as described above, a number of programs may exist that relate to a selected value or goal. In this example, the data processing system (FIG. 1, 100) may present a list of programs that relate to the value or goal. The data processing system (FIG. 1, 100) may generate the list based on metadata associated with the programs, and keyword searches within the programs, among other textual analysis methods. From this list, an individual may select a particular program, and its included steps. Upon selection of a program, the program steps may be automatically populated to the choice list as tasks. From the choice list, the user may complete the tasks or schedule the tasks to be completed on particular dates by moving them to a task list. In yet another example, the program steps may be automatically assigned a date, and populated to a task list. In this example, a user may still manipulate the scheduling and completion of the described tasks.

In another example, receiving (block 203) a number of steps based on the value, goal, or combinations thereof may include receiving a program generated by the user, via the publish engine (FIG. 1, 116), for example. More specifically, a user may create one or more steps to achieve a particular goal. In some examples, receiving (block 203) a number of steps may include concurrently receiving expert steps and user-created steps to achieve a particular goal.

An example of receiving (block 201) an input value, receiving (block 202) the selection of a goal relating to the value, and receiving (block 203) a number of steps based on the value, goal, or combinations thereof is given as follows. An individual may determine that he/she would like to develop the value of career development. Accordingly, the data processing system (FIG. 1, 100) may receive (block 201) the input value of career development as described above such as, for example, by selecting a career development icon or via a user's manual entry of the term “career development.” To this end, the individual may determine that a goal related to this value may be innovative thinking. The data processing system (FIG. 1, 100) may then receive (block 202) the goal of innovative thinking via manual entry. The data processing system (FIG. 1, 100) may then present a list of programs relating to the goal of innovative thinking. In addition to presenting the list of programs, the data processing system (FIG. 1, 100) may present contextual information such as authorship, reviews, credentials, endorsements, and statistics relating to the use, credibility, and success of the program, among other contextual information for the programs listed. The individual may browse through, search for, or otherwise research the program list and may find, and select, a program that he/she believes will help in the attainment of the innovative thinking goal. Accordingly, the data processing system (FIG. 1, 100) may receive (block 203) a selection of a number of steps, in this example an expert program, based on the input goal of innovative thinking.

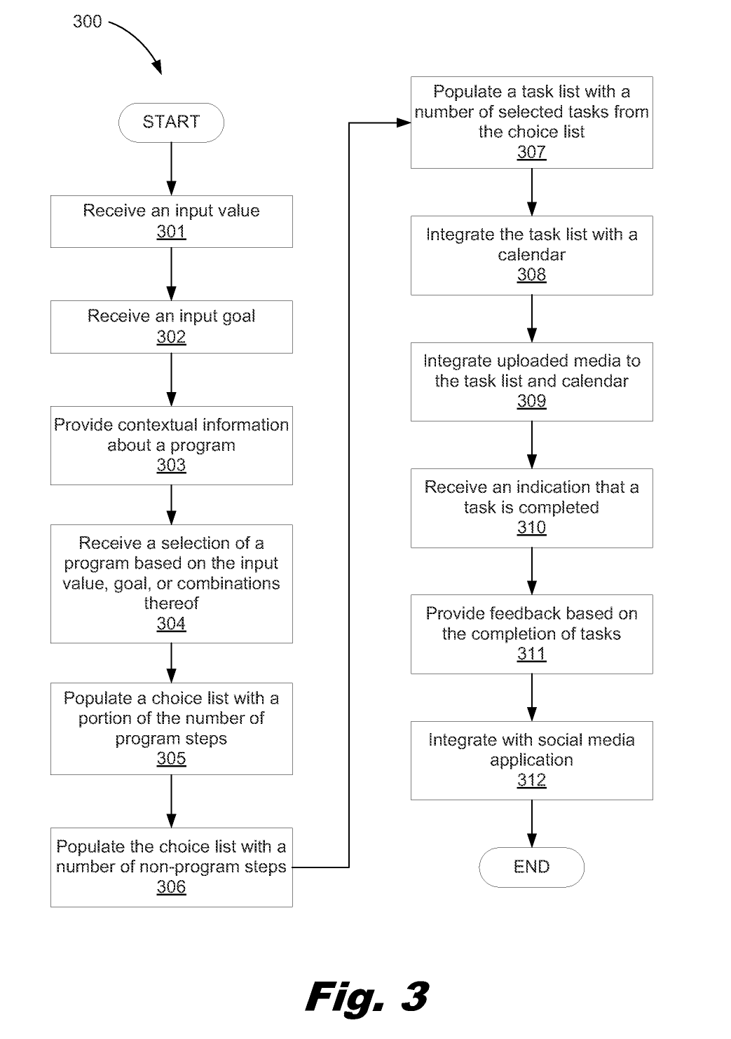

The data processing system (FIG. 1, 100) may populate (block 204) a choice list with a portion of the number of steps. For example, upon reception (block 203) of a number of steps from a program, a portion, such as a first step, may be populated (block 204) to the choice list. In the choice list, the populated portion of the number of steps are represented as tasks. Accordingly, the program steps of a selected program may be moved to a choice list, and identified as tasks, which may be visualized on a GUI of the display device (FIG. 1, 106). In some examples, the data processing system (FIG. 1, 100) may populate (block 204) the choice list with a portion of a number of program steps based on the selection of a program, and independent of any other action by the individual. The choice list may be populated with a number of program steps from a number of programs. The choice list may also be populated with a number of non-program steps as will be described in connection with FIG. 3.

The choice list may be a list of tasks that do not yet have a temporal assignment. In other words, the tasks of the choice list may not have a particular date or time assigned for completion. Drawing from the example above, populating (block 204) a choice list with a portion of the number of program steps from an innovative thinking program may include adding to the choice list the program step of “spending 15 minutes in your idea book,” “talking to someone in a field different than yours,” or “touring an innovative company.”

In some examples, populating (block 204) the choice list may include populating the choice list with a first step of a selected program. For example, a program may include twelve steps to be performed sequentially. In this example, the data processing system (FIG. 1, 100) may populate just the first program step of the twelve-step program to the choice list, while preventing other program steps of the twelve-step program from being populated to the choice list. In this example, once the first program step is completed or scheduled, or a task corresponding to the first program step is completed or scheduled, the data processing system (FIG. 1, 100) may populate the choice list with the second program step of the selected program.

In still another example, a program may suggest or require that a number of the program steps be performed in a particular order. In this example, the data processing system (FIG. 1, 100) may populate (block 204) the choice list with a number of preliminary program steps that are to be performed before a number of subsequent program steps. This selective population of the choice list may occur anywhere within the course of program steps and at any point within the program as defined by the program.

The data processing system (FIG. 1, 100) may populate (block 205) a task list with a selected number of tasks from the choice list by assigning a temporal value to the selected number of tasks. As described above, the choice list may include a number of tasks. An individual may indicate, via a GUI on the display device (FIG. 1, 106) that a particular task will be performed on a particular date, or otherwise assign a temporal value to a task on the choice list. Accordingly, the data processing system (FIG. 1, 100) may move the particular task to a task list that corresponds to the date selected by the user. Again, drawing from the example above, populating (block 205) a task list with a number of tasks from an innovative thinking program may include assigning the task of “spending 15 minutes in your idea book” a one week deadline.

Another example of populating (block 205) a task list with a selected number of tasks from the choice list is given as follows. In this example, an individual may select a program that is scheduled to be performed throughout, for example, 12 weeks, with one program step being performed each week. In this example, to accommodate his/her schedule, an individual may assign two tasks to a task list corresponding to one week, and assign zero tasks to the following week. Accordingly, the data processing system (FIG. 1, 100) may populate the first week's task list with the two selected tasks and may populate the second week's task list with no tasks. In other words, the data processing system (FIG. 1, 100) may populate (block 205) a task list based on a priority level selected by the individual.

In another example, an author of a program may prescribe a schedule for completing the program steps. Upon selection of the program, or independently, a user may adopt the schedule. Adopting the schedule may automatically schedule and populate (block 205), each program step into a user's task list.

A number of program steps including all the program steps within the program may be populated to a task list. In this example, the individual may select the program steps he/she wishes to perform, and may select those program steps in any order. Accordingly, the individual is free to choose the order and pace of the scheduling of the program steps and, therefore, the performance of the program steps.

FIG. 3 is a flowchart showing a method (300) for implementing value-based organization, according to another example of the principles described herein. The method (300) may be performed by the data processing system (FIG. 1, 100). The method (300) may include receiving (block 301) an input value. In some examples, this may be performed as described in connection with FIG. 2. The method (300) may include receiving (block 302) a selection of a goal related to the input value. This may be performed as described in connection with FIG. 2.

The data processing system (FIG. 1, 100) may provide (block 303) contextual information about a program associated with a value or goal. For example, the data processing system (FIG. 1, 100) may include information about the author of the program including credentials and endorsements. The data processing system (FIG. 1, 100) may also further describe the program including publication information, accolades and a more detailed description of the program. Yet further, the data processing system (FIG. 1, 100) may include information on public use of the program, reviews of the program, statistics, and other notes about the program. An individual may rely on this contextual information in selecting a program. In some examples, the contextual information may indicate whether the program was authored by a professional author in the field of interest.

The data processing system (FIG. 1, 100) may receive (block 304) a selection of a program based on the input value, goal, or combinations thereof. In some examples, this may be performed as described in connection with FIG. 2.

The data processing system (FIG. 1, 100) may populate (block 305) a choice list with a portion of the number of program steps of the selected program as tasks of the choice list. In some implementations, this may be performed as described in connection with FIG. 2.

The data processing system (FIG. 1, 100) may populate (block 306) the choice list with a number of non-program steps as tasks of the choice list. As described above, in addition to steps relating to a selected program, the choice list may be populated with non-program steps. For example, in addition to participating in a weight loss program, an individual may have a non-program duty to “review son's homework assignment.” In this example, the data processing system (FIG. 1, 100) may populate (block 306) the choice list with the review homework assignment duty.

Populating (block 306) the choice list with a number of non-program steps may include receiving the non-program steps. The non-program steps may be received from a number of sources. Examples of sources of non-program steps includes emails, text messages, task lists, non-program steps entered via a touchscreen of an electronic device, and gestures from electronic pens, among other electronic sources.

The data processing system (FIG. 1, 100) may populate (block 307) a task list with a number of selected tasks from the choice list. In some examples, this may be performed as described in connection with FIG. 2.

The data processing system (FIG. 1, 100) may integrate (block 308) a task list with a calendar. For example, an individual may select a particular task from the choice list to be moved to a task list for a particular, day, week, month or other time interval. In this example, the data processing system (FIG. 1, 100) may display the task on a calendar according to the time interval selected by the individual. As will be described below, the calendar may be displayed on a GUI of the display device (FIG. 1, 106).

In another example, a number of calendars and task lists may be integrated into a single calendar and task list. A number of the calendar and task lists that are integrated may be commercially available calendaring and task management systems such as for example, OUTLOOK™ designed and distributed by Microsoft Corporation, or any other commercially available calendaring system. In this example, the processing system (FIG. 1, 100) integrates (block 308) the number of task lists and calendars within the same task list and calendar. In this manner, the individual may have the tasks associated with a calendaring system he/she regularly uses. This will, in turn, assist the user in being reminded of the tasks on a periodic basis such as throughout a given day. Other examples of commercially available calendaring and task management systems include EXCHANGE™ designed and managed by Microsoft Corporation, ICLOUD® designed and managed by Apple, Inc., and GOOGLE® designed and managed by Google Inc.

The data processing system (FIG. 1, 100) may integrate (block 309) uploaded media to a task list, calendar, or combinations thereof. This may be based on a time stamp of the uploaded media. For example, a task list may indicate a one mile run scheduled at 6:30 in the morning. During the run, the individual may take a picture. The individual may then upload the picture to the data processing system (FIG. 1, 100). Using the time stamp of the picture, the data processing system (FIG. 1, 100) may associate, store, or otherwise link, the picture to the scheduled task or the scheduled event via the data processing system (FIG. 1, 100). In this fashion, the data processing system (FIG. 1, 100) may provide a journaling, or diary, functionality.

The data processing system (FIG. 1, 100) may receive (block 310) an indication that a task is completed. For example, each task on a task list may include a radio button or other control mechanism allowing an individual to select whether or not they have completed a task. An individual may use this control mechanism to indicate they have completed a task. Accordingly, the data processing system (FIG. 1, 100) may receive (block 310) an indication that a task is completed. In another example, the user or the data processing system (FIG. 1, 100) may be allowed to indicate partial completion of a task.

In another example, a task may be automatically marked as completed based on a third party source. For example, a user may have a task placed in a task list to run a 4 mile run in preparation for a marathon. In this example, a third party application may determine if the user has run that particular distance. This information may be conveyed to the data processing system (FIG. 1, 100), or the data processing system (FIG. 1, 100) may obtain this information, and the data processing system (FIG. 1, 100) will indicate that the task has been completed.

Based on the completion of tasks, the data processing system (FIG. 1, 100) may provide (block 311) feedback to the individual. For example, the data processing system (FIG. 1, 100) may indicate to the individual whether or not they are completing tasks relating to their selected values and/or goals. Accordingly, the individual may rely on the received feedback to select new goals, adjust tasks, or combinations thereof.

The method (300) may also include integrating (block 312) the events, tasks, goals, or values with a social media application. For example, users may post progress through a program on social media sites. Users may also provide commentary about different programs, goals, events, etc.

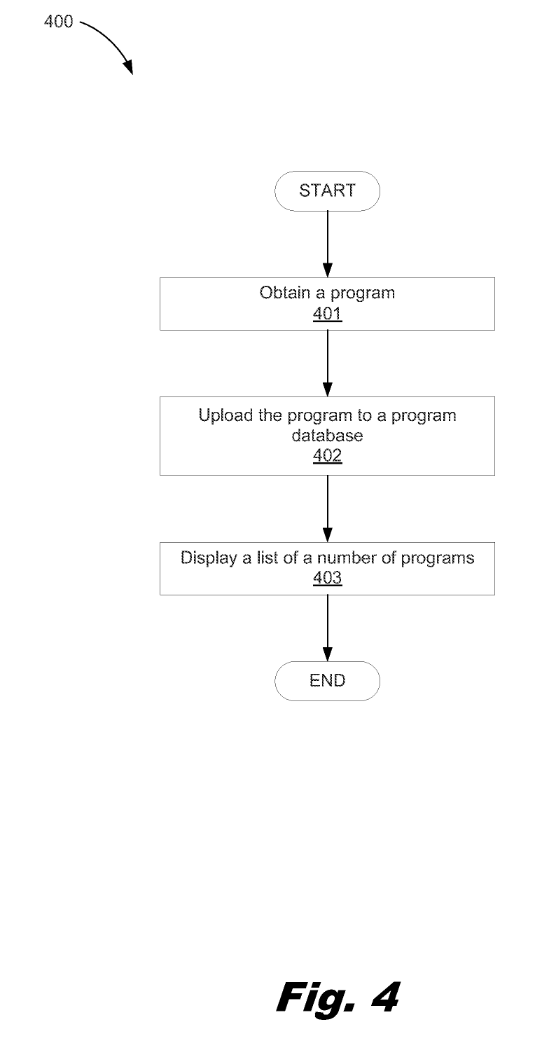

FIG. 4 is a flowchart showing a method (400) for providing value-based organization, according to one example of the principles described herein. The method (400) may be performed by the data processing system (FIG. 1, 100). The data processing system (FIG. 1, 100) may obtain (block 401) a program. As described above, a program may include a number of program steps whose execution is intended to achieve a particular end, or goal. A program may be authored by an individual with credentials, or expertise in a particular field. For example, a financial planning expert may have developed a program for sound investing. In another example, a program may be authored by a lay person, or rather, someone without expertise in a particular field. In any case, the data processing system (FIG. 1, 100) may obtain (block 401) the program.

Obtaining (block 401) the program may include automatically uploading the program from an electronic device. For example, the data processing system (FIG. 1, 100) may obtain (block 401) a program uploaded from an electronic device that is connected to the data processing system (FIG. 1, 100) via the internet, another network, among other types of communication electrical coupling.

In another example, the data processing system (FIG. 1, 100) may obtain (block 401) a program via a user interface that allows an author to insert the information relating to the program such as, for example, program steps, descriptions, keywords, and author information, among other information relating to the program. Obtaining (block 401) a program may include publishing the program into a format usable by the data processing system (FIG. 1, 100). For example, the data processing system (FIG. 1, 100) may add programming code, or formatting, to the program such that the program steps can be uploaded to the choice list.

The data processing system (FIG. 1, 100) may upload (block 402) the program to a program database (FIG. 1, 111). As described above, the program database (FIG. 1, 111) may include a number of programs uploaded by a number of individuals, which may include authors with expertise in a particular field. From this program database (FIG. 1, 111) the data processing system (FIG. 1, 100) may retrieve programs, and program steps based on input received from individuals. Storing the programs in a central program database (FIG. 1, 111) may be beneficial in that it centralizes a number of programs in a single location from which individuals can search for, or browse for a particular program.

The data processing system (FIG. 1, 100) may display (block 403) a list of the number of programs. For example, as an individual indicates a value that he/she wishes to develop, the data processing system (FIG. 1, 100) may display (block 403) a number of programs that relate to the input value or goal. Accordingly, an individual may select a particular program, and carry out the program steps entailed therewith.

In some examples, the data processing system (FIG. 1, 100) may organize the list based on a number of criteria. For example, the programs with the highest success rate, the highest reviewed programs, or combinations thereof may be positioned first on the list. Additionally, the data processing system (FIG. 1, 100) may display the list based on user input. For example, the individual may select a number of criteria by which the program list is narrowed.

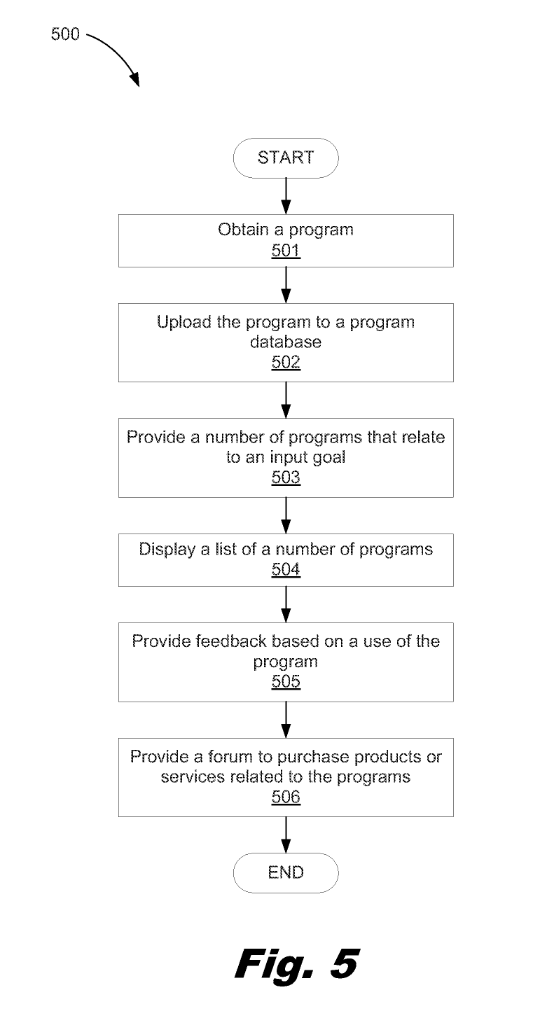

FIG. 5 is a flowchart showing a method (500) for providing value-based organization, according to another example of the principles described herein. The method (500) may be performed by the data processing system (FIG. 1, 100). The data processing system (FIG. 1, 100) may obtain (block 501) a program. In some examples, this may be performed as described in connection with FIG. 4.

The data processing system (FIG. 1, 100) may upload (block 502) a program to the program database (FIG. 1, 111). In some examples, this may be performed as described in connection with FIG. 4.

The data processing system (FIG. 1, 100) may provide (block 503) a number of programs that relate to an input value or goal. For example, the data processing system (FIG. 1, 100) using metadata, input contextual information, or keywords, may identify a number of programs in the program database (FIG. 1, 111) as relating to a particular value or goal. Upon receiving an input value or goal, the data processing system (FIG. 1, 100) may identify a number of programs that relate to the input value or goal. The data processing system (FIG. 1, 100) may display (block 504) a list of the number of programs. In some examples, this may be performed as described in connection with FIG. 4.

The data processing system (FIG. 1, 100) may provide (block 505) feedback to an author of the program based on the use of the program. Such feedback may include an indication of the use of the program. For example, the feedback may indicate to an author how many individuals have used the program, how many individuals have completed the program, what portion of the program is generally completed, steps of the program that are problematic for individuals, steps of the program that are particularly appealing to individuals, skipped steps, statistical feedback, and individual comments, among other types of feedback. From this information, the author may change a number of steps within the program to make it more successful or appealing. In this manner, the author of a program may be able to refine the program any number of times.

The data processing system (FIG. 1, 100) may provide (block 506) a forum to purchase products or services related to the programs. For example, the data processing system (FIG. 1, 100) may provide a marketplace where authors of programs may sell the program, books, audio recordings, merchandise, additional services, and other products and services.

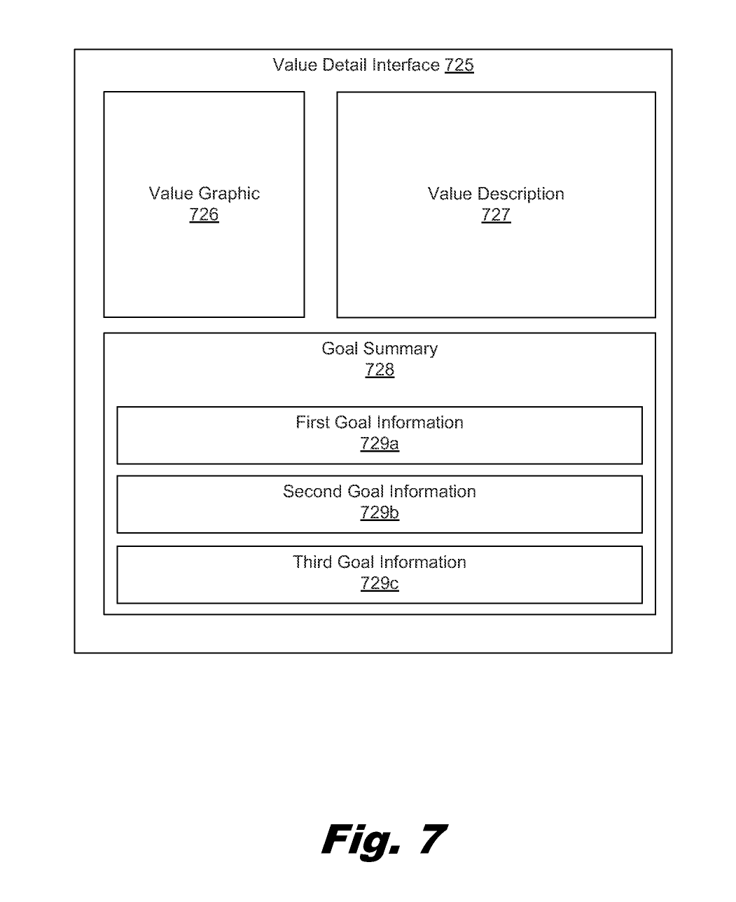

FIG. 6 is a block diagram of a value interface (620), according to one example of the principles described herein. The value interface (620) may be part of a GUI presented on the display device (FIG. 1, 106) that presents a number of values selected by an individual. The value interface (620) may also facilitate in the selection of a value to develop. The value interface (620) may display a number of value icons (621) that correspond to values the individual has indicated as valuable, or that he/she would like to develop. In some examples, the individual may select an image, or text that relates to the value selected. For example, if a first value relates to family, a picture of the individual's family may be used as the first value icon (621a). In some examples, selecting the value icons (621) may direct the individual to a value detail interface that gives more information relating to the value. More detail concerning the value detail interface is given below in connection with FIG. 7.

As described above, the data processing system (FIG. 1, 100) may receive an input value. In some examples, an individual may input a value via the value interface (620). For example, the individual may select a new value icon (622) and enter information relating to the value. For example, the individual may enter a value name, a value description, a mission statement associated with the value, and a customized icon representative of the value.

FIG. 7 is a block diagram of a value detail interface (725) according to one example of the principles described herein. The value detail interface (725) may be selected by selection, such as clicking, using a mouse, or via a gesture on a touch-sensitive display, of a value icon (FIG. 6, 621). The value detail interface (725) may provide additional detail relating to a particular value. The value detail interface (725) may include a value graphic (726) relating to the value. For example, if the value relates to a user's family, the value graphic (726) may be an image of the individual's family.

The value detail interface (725) may include a value description field (727). The value description field (727) may include text describing the value. For example, the value description field (727) may include a value title and a description of the value and how it may benefit the user. The value detail interface (725) may include a button, or other control mechanism, to manipulate the value graphic (726), the value description (727) or combinations thereof. For example, an “edit” button may allow a user to change the value graphic (726), the value description (727), or combinations thereof. According to the systems and methods described herein, a value may be visually indicated using a colored highlight, or other color indication. Accordingly, in addition to editing the name and description of the value, a user may edit a color associated with the value such that it might be more easily identifiable to the user.

In some examples, the value detail interface (725) may also include navigation controls such as left and right arrows to navigate between different value detail interfaces (725) pertaining to different values as indicated by the value icons (FIG. 6, 621).

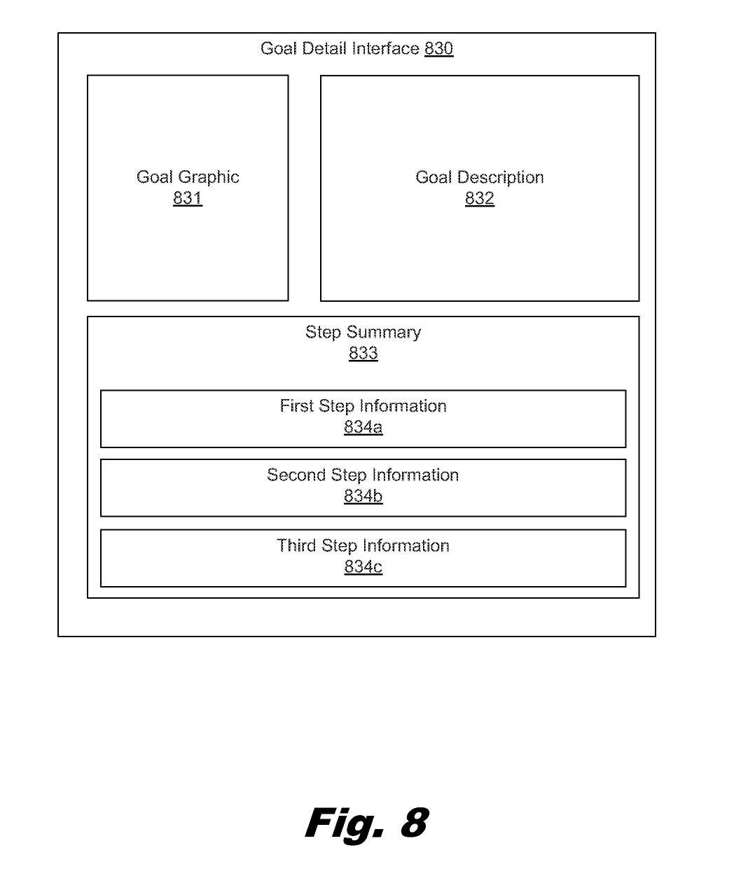

The value detail interface (725) may also include a goal summary field (728) that identifies the goals associated with the value and a number of goal information fields (729a, 729b, 729c) that contain additional information related to the goals. The goal information fields (729) may include at least one of an icon, a goal title, a scheduled date for completion as well as a progression indicator. For example relating to a first goal of purchasing a camera, the first goal information field (729a) may include an icon of a camera, the goal title of “purchase new camera,” as well as a target date for completion. As described above, a goal may be broken down into a number of steps. Accordingly, the first goal information field (729a) relating to the goal of purchasing a new camera may also include an indication, such as a status bar, of how far along a user is towards achieving that goal. The goal summary field (728) may also include a button, or other control mechanism, whereby a new goal may be added to the goal summary field (728). The goal information fields (729) may also include a button, or other mechanism, that allows a user to view a goal detail interface as described in more detail in FIG. 8. While reference is made to specific elements of a goal information fields (729), the goal information fields (729) may include various elements.

FIG. 8 is a block diagram of a goal detail interface (830), according to one example of the principles described herein. The goal detail interface (830) may be presented via selection from the goal information fields (FIG. 7, 729). For example, a user, via a control mechanism such as a button, may access the goal detail interface (830) from the value detail interface (FIG. 7, 725).

The goal detail interface (830) may include specific information relating to a goal. For example, the goal detail interface (830) may include a goal graphic (831) relating to the goal. The goal detail interface (830) may be accessed by selecting an icon from a goal information field (FIG. 7, 729) relating to the goal.

The goal detail interface (830) may include a goal description field (832). The goal description field (832) may include text describing the goal. For example, the goal description field (832) may include a goal title and a description of the goal and how it may benefit the user's life. The goal description field (832) may also include other information such as a beginning date of the goal as well as a target date for completion. In some examples, these dates may be synchronized with the calendar.

The goal detail interface (830) may include a button, or other control mechanism, to manipulate the goal graphic (831), the goal description (832) or combinations thereof. For example, an “edit” button may allow a user to change the goal graphic (831), the goal description (832), or combinations thereof. As described above, a value may be visually indicated using a colored highlight, or other color indication. Accordingly, in addition to editing the name and description of the goal, a user may associate the goal to a value based on a color corresponding to the value such that it might be more easily associated with a value.

The goal detail interface (830) may include a step summary field (833) that identifies the steps associated with the goal and a number of step information fields (834a, 834b, 834c) that contain additional information related to the steps. For example, a first step information field (834a) may communicate information relating to a first step. The step information fields (834) may include information such as a step name, and a status of the step. For example, the first step information field (834a) may indicate that a particular step is scheduled to be performed on a particular date. The step information fields (834) may also allow a user to take particular action with regards to a step. For example, the step information fields (834) may include a button, or other control mechanism, which upon activation, may allow the user to indicate that a step has been completed. In this example, if the step is associated with a calendar event, the calendar event may be removed from the calendar.

If a step has not been scheduled, a button, or other control mechanism, may allow the user to schedule the step for a particular date, for example by presenting the user with a calendar, from which the user may select a date to complete the step.

The step information fields (834) may also include a button, or other control mechanism, to display additional information, such as a description of the step. The step information fields (834) may include a button, or other control mechanism, to allow a user to manipulate the step information such as step name and step description.

The step summary field (833) may also indicate information relative to “milestone” progression, such as the number of steps completed towards achieving a milestone of the goal. The step summary field (833) may also allow a user to create additional steps, delete certain steps, or to resurrect previously deleted steps.

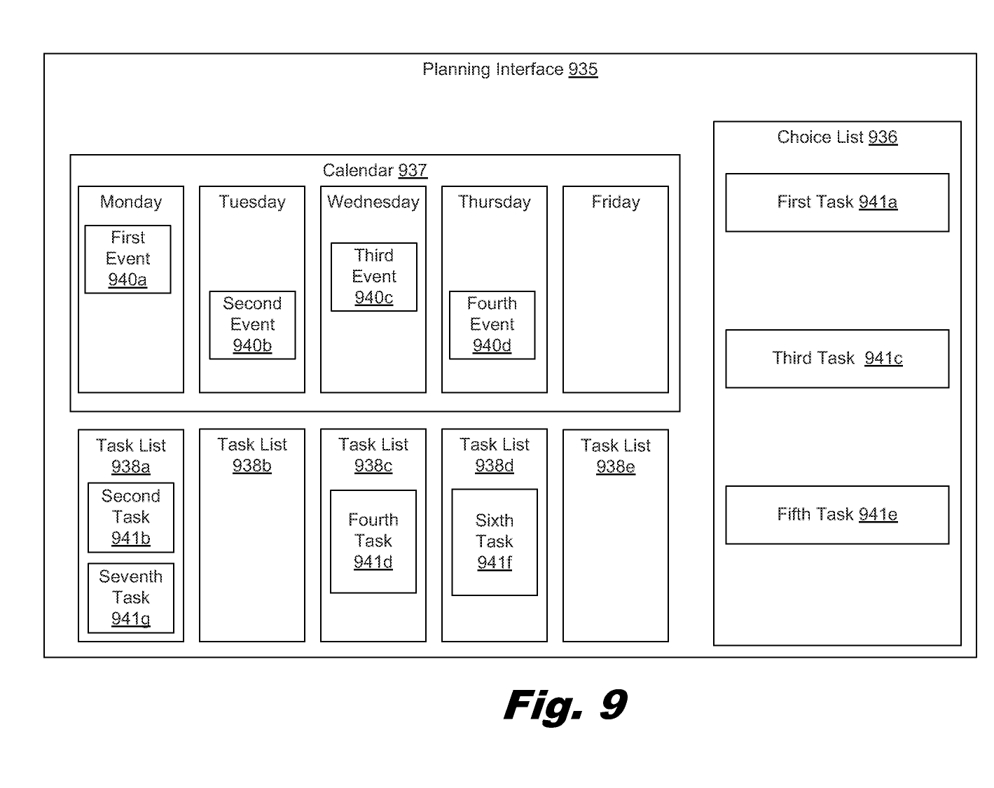

FIG. 9 is a block diagram of a planning interface (935), according to one example of the principles described herein. The planning interface (935) may be a GUI that allows an individual to manage a choice list (936), a calendar (937) and a number of task lists (938). As described above, the choice list (936) may include a number of tasks (941a, 941c, 941e) that correspond to program steps and non-program steps. The tasks (941a, 941c, 941e) as presented in the choice list (936) have not yet received a temporal value or commitment. When assigned a temporal value or commitment a task (941) is moved to a task list (938) and is no longer presented in the choice list (936). For example, as depicted in FIG. 9, a number of tasks (941b, 941d, 941f, 941g) have been moved to various task lists (938a, 938c, 938d) and are no longer displayed in the choice list (936). The program steps may be added to the choice list (936) as a program is selected by an individual.

In some examples, the choice list (936) may include a search field that allows an individual to search for a particular task (941a, 941c, 941e) of the choice list (936). In some examples, a number of tasks (941) in the choice list (936), and the task lists (938) as well, may indicate the source of the task (941). For example, a first task (941a) that relates to a program step may include an icon indicating that they come from a particular program. In another example, a mail icon may indicate that a non-program step associated with the third task (941c) originated from an email message. The choice list (936) may also include an indication of a value associated with the task (941). For example, a first task (941a) may include a color highlight, a color icon, or combinations thereof that associate the first task (941a) with a value with the same color highlight, or color icon.

Each task (941a, 941c, 941e) field may also include a number of control functions relating to that task (941a, 941c, 941e). For example, the control functions may include an element that allows an individual to remove a task (941a, 941c, 941e) from the choice list (936), or to mark a task (941a, 941c, 941e) from the choice list (936) as completed. For example, clicking an “x” icon next to a task (941a, 941c, 941e) in the choice list (936) may remove the task (941a, 941c, 941e) from the choice list (936) and indicate that the task (941a, 941c, 941e) was removed, or skipped. By comparison, clicking a “✓” icon next to a task (941a, 941c, 941e) in the choice list (936) may remove the task (941a, 941c, 941e) from the choice list (936) and indicate that the task (941a, 941c, 941e) has been completed.

The planning interface (935) may also include a number of task lists (938a, 938b, 938c, 938d, 938e) that include a number of tasks (941b, 941d, 941f, 941g) that have been assigned a temporal value or commitment. Tasks (941) may receive a temporal assignment when an individual drags and drops a task (941) from the choice list (936) to a task list (938) or a day on the calendar (937). A task list (938) may correspond to a particular day in the calendar (937). For example, a first task list (938a) may correspond to Monday of a particular week.

As with the choice list (936), the tasks (941b, 941d, 941f, 941g) in a task list (938) may indicate the source of the task (941b, 941d, 941f, 941g). For example, a second task (941b) that relates to a program step may include an icon indicating that they come from a particular program. In another example, a mail icon may indicate that a non-program step associated with the second task (941b) originated from an email message. The task lists (938) may also include an indication of a value associated with the task (941). For example, a second task (941b) may include a color highlight, a color icon, or combinations thereof that associate the second task (941b) with a value with the same color highlight, or color icon.

In some examples, a task (941) may be assigned a particular priority. For example, in a first task list (938a), a second task (941b) may be assigned a higher priority than a seventh task (941g) scheduled for that date. Each task (941) may be assigned a particular general priority level. For example, each task (941) may be assigned an “A” priority level, a “B” priority level, or a “C” priority level. Moreover, each task (941) within a particular priority level may be assigned a narrower priority value. For example, a particular task (941) may be assigned an “A1” priority indicating it as first priority within the “A” priority level. By comparison, another particular task (941) may be assigned a “B2” priority indicating it as second priority within the “B” priority level. The priority may be indicated by an icon positioned next to a task (941) within a task list (938).

The tasks (941b, 941d, 941f, 941g) in the task lists (938) may also include an element that allows an individual to remove a task (941b, 941d, 941f, 941g) from a task list (938), to mark a task (941b, 941d, 941f, 941g) from a task list (938) as completed, or to view, add, or edit notes to a task (941b, 941d, 941f, 941g). For example, clicking an “x” icon next to a task (941b, 941d, 941f, 941g) may remove the task (941b, 941d, 941f, 941g) from the task list (938) and indicate that the task (941b, 941d, 941f, 941g) was removed, or skipped. By comparison, clicking a “✓” icon next to a task (941b, 941d, 941f, 941g) may remove the task (941b, 941d, 941f, 941g) from the task list (938) and indicate that the task (941b, 941d, 941f, 941g) has been completed. In one example, by dragging and dropping, or taking other action to move it, a task (941b, 941d, 941f, 941g) may be removed from the task list (938) and re-populated in the choice list (936). Clicking another icon next to a task (941b, 941d, 941f, 941g) may open a note interface in which an individual can view, add, or edit notes relating to the task (941).

In some examples, the planning interface (935) may include a calendar (937) depicting any number of calendar days. The calendar (937) may display appointments, activities, and other events for a particular time interval. For example, as depicted in FIG. 9, the calendar (937) may display an agenda for a five-day period of time. The calendar (937) may display appointments relating to the different facets of an individual's life. For example, the calendar (937) may display professional appointments, family activities, among other activities, appointments, and events (940). In some examples, the planning interface (935) may display a secondary calendar having a different time range than the calendar (937). For example, a second calendar, for example a smaller monthly calendar, may allow a user to select a different date range to view.

The calendar (937) may include a number of events (940a, 940b, 940c, 940d) that indicate temporal commitments that a user has. In some examples, events (940) in the calendar (937) may be associated with a particular value. An event (940) in a calendar (937) may include a color highlight that associates the event (940) with a value indicated by the same color highlight. For example, a calendar (937) event (940) for an “innovation boot camp,” may be highlighted by the color purple. In this example, the color purple may be associated with the value of innovative thinking. The planning interface (935) may also include a toolbar (not shown) that manages the planning interface (935). For example, the toolbar may allow an individual to change the number of days shown on the calendar (937), or to show a particular period of time on the calendar (937). In other words, while FIG. 9 depicts a five-day calendar (937), any number of days may be displayed on the calendar (937) via settings in the toolbar. The planning interface (935) may include other functionalities that allow a user to alter the display, such as adjusting the type of calendar (monthly, weekly), to determine which type of information to display (tasks only, events only, tasks and events), which calendar to display (personal, work, specific third-party calendar).

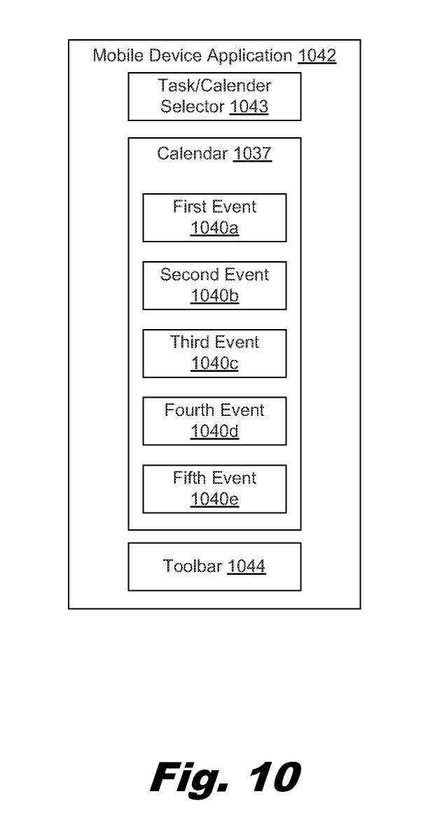

FIG. 10 is a block diagram of an event view of a mobile device application (1042) for value-based organization, according to one example of the principles described herein. The systems and methods described herein may be provided on a mobile device. To access a mobile device application (1042), a user may login to the application via a username and password. Upon successful entry of the username and password, a user may be presented with a blank task list or calendar or the user's specific task list or calendar.

The calendar view may include a calendar (1037) that displays the events (1040a, 1040b, 1040c, 1040d, 1040e) that are scheduled for that day. As described above, an event (1040) may be associated with a particular value. Accordingly, the calendar (1037) may present a color indication to associate the events (1040) with corresponding values. A user may select an event (1040) by touching, or otherwise selecting, the event (1040) to view an event detail interface and to edit event information.

The event detail interface may include a number of fields that allow a user to create a new event (1040) or modify an existing event (1040). Examples of such fields include a date field, a start time field, an end time field, a location field, a guests field, a reminder field, a tags field and a description field. The tags field may allow an individual to associate the event with a particular value. Via the tags field, a user may create a new tag. By selecting any of these fields, a user may adjust the value of the field, and that particular detail via user actions such as manual entry of field value, selection from pre-defined field values, or other selection of field values as offered by the mobile device application (1042).

The mobile device application (1042) may include a toolbar (1044) that includes a number of buttons, or other control mechanisms such as a touchscreen selection area, to carry out different functions. Examples of control mechanisms include an “add” button, a “today” button, a button to display the choice list, and a button to access social media applications.

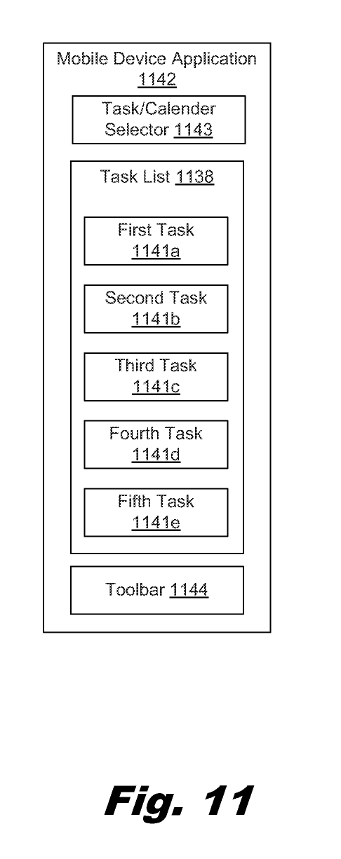

The mobile device applications (1042) may also include a task/calendar selector (1043) to toggle between the calendar view and the task view. When the selector (1043) is set to events, a user may see the calendar (1037) of events for the day as depicted in FIG. 10. When the selector (1043) is set to tasks, the user may see the list of tasks that are assigned for that particular date as described below in FIG. 11.

FIG. 11 is a block diagram of a task view of a mobile device application (1142) for value-based organization, according to one example of the principles described herein. The task view may include a task list (1138) that displays the tasks (1141a, 1141b, 1141c, 1141d, 1141e) that are scheduled for that day. As described above, tasks (1141) may be associated with a particular value. Accordingly, the mobile device application (1142) may present a color indication to associate tasks (1141) with corresponding values. A user may select a task (1141) by touching, or otherwise selecting, the task (1141) to view a task detail interface and to edit task information.

The task detail interface may include a number of fields that allow a user to create a new task (1141) or modify an existing task (1141). Examples of such fields include a priority field, a due date field, a location field a tags field, a reminder field, and a description field. The tags field may allow an individual to associate the task (1141) with a particular value. Via the tags field, a user may create a new tag. By selecting any of these fields, a user may adjust the value of the field, and that particular detail via user actions such as manual entry of field value, selection from pre-defined field values, or other selection of field values as offered by the mobile device application (1142).

A user may also edit a task (1141) directly via the task list (1138). For example, a user may make a gesture, such as a swipe, to a task (1141) to reveal a “✓” icon. Upon release or completion of the swipe, a task (1141) may be marked as completed. In some examples, a completed task (1141) may remain displayed, but may be darkened, crossed-out, may include a “✓” icon, or be otherwise visually altered to indicate that a task (1141) has been completed.

Via the task list (1138) a user may move a task (1141) from the task list (1138) to the choice list (FIG. 9, 936). For example, a user may make a gesture, such as a swipe opposite the swipe to reveal the “✓” icon, to reveal an icon associated with the choice list (FIG. 9, 936). Upon release or completion of the swipe, a task (1141) may be moved from the task list (1138) to the choice list (FIG. 9, 936).

The mobile device application (1142) may also allow a user to adjust the relative priorities of the tasks (1141) via a drag and drop mechanism of the mobile device application (1142). For example, the third task (1141c) may be promoted in priority by dragging the third task (1141c) to a position superior to the second task (1141b) as indicated in FIG. 11.

The mobile device application (1142) may also include a mechanism to add a new task (1141) to the task list (1138). For example, a user may make a gesture, such as a swipe down on the task list (1138) to reveal a new task field. In other examples, a new task may be generated by clicking on an “add” button from the toolbar (1144). Doing so may present the task detail interface. The mobile device application (1141) may include a toolbar (1144) and a task/calendar selector (1143) similar to the toolbar (FIG. 10, 1044) and the task/calendar selector (FIG. 10, 1043) described in connection with FIG. 10.

The mobile device applications (FIG. 10, 1042; FIG. 11, 1142) may allow a user to select a particular date to view. For example, a user may swipe, or tap, a portion of the mobile device left or right to view successive or previous dates. Similarly, a user may tape on a date indicator which may present the user with a calendar from which a user may select a particular date to view the events and/or tasks for that date.

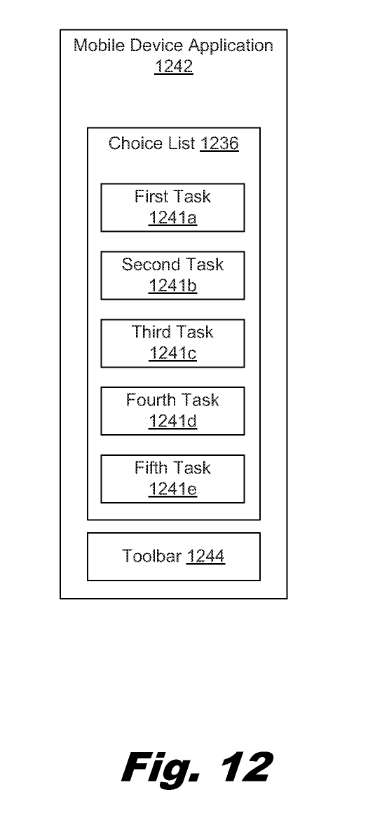

FIG. 12 is a block of a choice list interface of a mobile device application (1242), according to one example of the principles described herein. The choice list interface may be accessed by tapping on the choice list icon from the toolbar (FIG. 10, 1044, FIG. 11, 1144). The choice list (1236) displays a number of tasks (1241a, 1241b, 1241c, 1241d, 1241e) that are based on non-program steps, or program steps, that have not yet been assigned a temporal date. In some examples, when a task (1241) has a particular due date and that due date has passed, the task (1241) may be moved back to the choice list (1236) with an indication, such as an exclamation mark or other indication, that the task (1241) relates to a previously assigned task (1241) that has not been completed.

The choice list (1236) may allow a user to edit a task (1241). For example, a user may make a gesture, such as a swipe to reveal a “✓” icon. Upon release or completion of the gesture, a task (1241) may be marked as completed. In some examples, a completed task (1241) may remain displayed, but may be darkened, crossed-out, may include a “✓” icon, or may be otherwise visually altered to indicate that a task (1241) has been completed. Marking a task (1241) as completed may also move the task to a task list (FIG. 9, 938) corresponding to the day on which the task is marked as completed.

The choice list interface may allow a user to assign a task (1241) to a particular date. For example, a user may make a gesture, such as a swipe, relative to a first task (1241a) to move the item into a task list (FIG. 11, 1138) associated with the current day.

The choice list interface may also allow a user to adjust the relative priorities of the tasks (1241) via a drag and drop mechanism of the mobile device application (1242). For example, the third task (1241c) may be promoted in priority by dragging the third task (1241c) to a position superior to the second task (1241b).

The choice list interface may also include a mechanism to add a new task (1241) to the choice list (1236). For example, a user may make a gesture, such as a swipe down on the choice list (1236) to reveal a new task field. In other examples, a new task may be generated by clicking on an “add” button from the toolbar (1244). Doing so may present the task detail interface. The choice list interface may also include a toolbar (1244) similar to the toolbars described above.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (FIG. 1, 101) of the data processing system (FIG. 1, 100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe systems and methods for implementing and providing value-based organization. The methods may include receiving an input value, receiving a selection of a program based on the input value, in which the program comprises a number of program steps, populating a choice list with a number of program steps of a selected program, and populating a task list with a number of entries from the choice list, in which a task list comprises a number of tasks. These systems and methods may have a number of advantages, including: (1) integrating a calendar with a task list and a choice list including a number of program steps; (2) facilitating completion of a program at an individual's customized pace; (3) practical implementation, including intermediate steps, of a program; and (4) facilitating value based habit formation.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of value-based organization comprising, with a processor:
receiving an input value;
receiving a selection of a goal, in which the goal is associated with the input value;
receiving a number of steps based on the value, goal, or combinations thereof;
populating a choice list with a portion of the number of steps, the portion populated being a number of tasks in the choice list; and
populating a task list with a selected number of tasks from the choice list by assigning a temporal value to the selected number of tasks.

2. The method of claim 1, further comprising integrating the task list with a calendar.

3. The method of claim 1, in which the number of steps are part of a program.

4. The method of claim 3, further comprising providing contextual information about the program.

5. The method of claim 1, in which populating a choice list with a number of steps comprises populating the choice list with a first step.

6. The method of claim 5, further comprising populating the choice list with a second step when a task corresponding to the first step is completed, scheduled, or combinations thereof.

7. The method of claim 1, further comprising receiving an indication that a task is completed.

8. The method of claim 1, in which populating the task list with a number of entries from the choice list further comprises populating the task list based on an indicated priority of the number of entries.

9. The method of claim 1, further comprising providing feedback based on the completion of tasks.

10. The method of claim 1, further comprising integrating uploaded media to a task list, an event, or combinations thereof.

11. A method of providing value-based organization comprising, with a processor:
obtaining a program, in which the program comprises a number of program steps;
uploading the program to a program database; and
displaying a list of a number of programs.

12. The method of claim 11, further comprising providing feedback based on a use of the program.

13. The method of claim 11, further comprising providing a forum to purchase products, services, or combinations thereof related to the program.

14. The method of claim 11, further comprising providing a number of programs that relate to a selected value, goal, or combinations thereof.

15. A system for value-based organization comprising:
a database for storing a number of programs, the number of programs comprising a number of program steps;
a display device to display the number of programs, a choice list, a task list, or combinations thereof;
a value generation engine to allow generation of a value;
a goal generation engine to allow generation of a goal based on the value;
a program generation engine to allow generation of a program based on the goal; and
a choice list generation engine to allow generation of a number of entries from the choice list.

16. The system of claim 15, further comprising a publish engine to publish the program in a format to be implemented by the program generation engine, the choice list generation engine, or combinations thereof.

17. The system of claim 15, further comprising an association engine to associate a task, a program step, a non-program step, or combinations thereof, with a value.

18. The system of claim 15, further comprising a journaling engine to facilitate record keeping.

19. The method of claim 15, further comprising a task list generation engine to allow input of contextual information relating to a task.

20. The method of claim 15, further comprising a goal generation engine to generate goals based on a value.
